(19) United States
(12) Patent Application Publication
(10) Pub. No.: US 2013/0248007 A1
(43) Pub. Date: Sep. 26, 2013

(54) IDC-Identification Cap

(71) Applicant: Frederick Richard Wallace, JR., Redwood City, CA (US)

(72) Inventor: Frederick Richard Wallace, JR., Redwood City, CA (US)

(73) Assignee: Frederick Richard Wallace, JR., Redwood City, CA (US)

(21) Appl. No.: 13/424,381

(22) Filed: Mar. 20, 2012

(51) Int. Cl. F16K 15/20

(52) U.S. Cl. 137/232

(57) ABSTRACT

Twisting off the existing cap that sits on the Valve of the tire is time consuming. Also one needs to check the vehicle to find the appropriate air-pressure for the tire. The IDC Cap is quick and convenient to remove just pull and the IDC Cap is removed or push the IDC Cap into place on the valve. In addition, there is identification on the top of the cap that corresponds with appropriate tire pressure or value that is required.

### CROSS-REFERENCE TO RELATED APPLICATIONS

Value caps have long been in existence since the invention of intertubes and tubeless tires as shown in the U.S. Pat. No. 1,162,099 TIES VALVE CAP. Caps of this type rely on removing and replacing the cap with a twisting action. U.S. Pat. Nos. 1,423,541 VALVE STEM CAP, 1,676,578 VALVE STEM COVER, 1,489,468 VALVE STEM CAP, 1,309,795 TIRE STEM CAP, 2,216,125 VALVE STEM CAP, and 1242995 VALVE STEM CAP all still require a twisting action to remove or replace the threaded cap although the degree of twisting is usually decreased from patent to patent.

### BACKGROUND OF THE INVENTION

This invention relates to a new Cap for the Valve on a tire, machinery or product. The IDC Cap pushes easily into place and will have the tire pressure or an identification molded or stamped on the top of the cap. The IDC Cap easily pushes into place to fit tightly, and held in place by friction. It will have raised or recessed digits, or letters, or alphanumeric mark, or a stamp on top.

### BRIEF SUMMARY OF THE INVENTION

This invention relates to a new Cap for the Valve on a tire, machinery or product. The IDC Cap pushes easily into place and will have the tire pressure or an identification molded or stamped on the top of the cap. It is a single piece Cap with digits, letters, alphanumeric mark or a stamp on top. The user pushes the Cap, which is a single piece of rubber or plastic, over the valve of a tire, machinery or product. No other caps are “push-on” and held in place by friction or labeled with raised or recessed digits, or letters, or alphanumeric mark, or a stamp on top. Twisting off the existing cap that sits on the Valve of the tire is time consuming. Also one needs to check the vehicle to find the appropriate air-pressure. The IDC Cap saves time.

### BRIEF DESCRIPTION OF THE SEVERAL VIEWS OF THE DRAWING

FIG. 1 is a line drawing view of the bottom of the cap

FIG. 2 is a line drawing view of the side of the cap

FIG. 3 is a line drawing view of the top of the cap

FIG. 4 is a line drawing view of the side with number of the cap

FIG. 5 is a line drawing view of the top with number of the cap

FIG. 6 is a line drawing view of the cap on a tire valve stem

FIG. 7 is a line drawing three-dimensional view of the cap

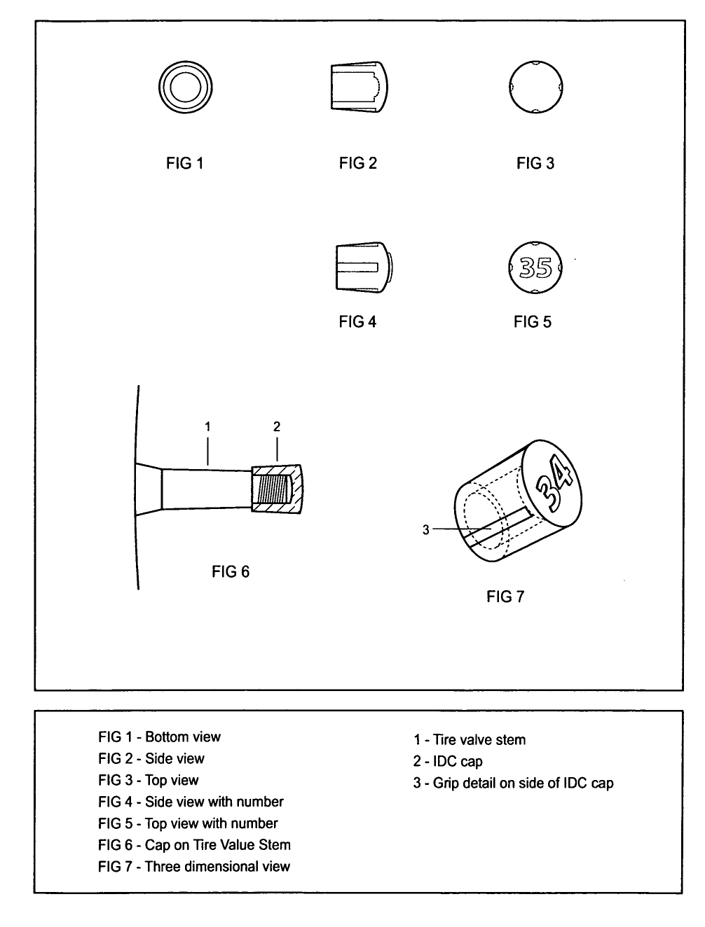

### DETAILED DESCRIPTION OF THE INVENTION

This invention relates to a new Cap for the Valve on a tire, machinery or product. The IDC Cap pushes easily into place and will have the tire pressure or an identification mark molded or stamped on the top of the cap.

The device is comprised of the following, the IDC Cap is pressed into position by the user and consists of a single piece of rubber or plastic that has raised or recessed digits, or letters, or alphanumeric mark, or a stamp on top. It is a single piece Cap with digits or letters or alphanumeric or a stamp on top. The user pushes the Cap, which is a single piece of rubber or plastic, over the valve of a tire or machinery or product and is held in place by friction.

To manufacture the cap, one enters into a contract with a plastics manufacture. That would require agreed upon quantity and cost per piece or part. If a stamp is required, contract with a stamping facility for the stamp on the top of the Cap. The IDC Cap can be manufactured in different sizes to fit a variety of valves. The top portion of the Cap can be modified into different shape and/or design and/or color. Anything can be stamped, printed or molded on the top of the Cap.

For a tire cap, a person would first verify the automobile manufacture tire pressure requirement and obtain a new IDC Cap with that correlating value on top of it, then twist off the existing cap on the valve and then push the new IDC Cap onto the valve.

It can be used to cap other valves: such as air valves, oil valves and connectors, e.g. audio connectors.

No other caps are “push-on pull-off” or labeled with raised or recessed digits, or letters, or alphanumeric mark, or a stamp on top.

Twisting off the existing cap that sits on the valve of the tire is time consuming. Also one needs to check the vehicle to find the appropriate air-pressure. The IDC Cap saves time.

1. A new cap design for a valve on a tire, machinery or product, such as air valves, oil valves or connectors, e.g. audio connectors.

2. The IDC cap as recited in claim 1, pushes easily into place.

3. The IDC cap as recited in claim 1, is held by friction.

4. The IDC cap as recited in claim 1, is easily pulled off to remove.

5. The IDC cap as recited in claim 1, will have raised or recessed digits, or letters, or alphanumeric mark, or a stamp on top.
